(19) United States
(12) Patent Application Publication
(10) Pub. No.: US 2023/0336995 A1
(43) Pub. Date: Oct. 19, 2023

(54) SYSTEM AND METHOD FOR ZERO CONFIGURATION WI-FI

(71) Applicant: Wyze Labs, Inc., Kirkland, WA (US)

(72) Inventors: Yingbo Hu, Irvine, CA (US); Frederik Delacourt, Mercer Island, WA (US); Chan-Hsin Chang, Palos Verdes Estates, CA (US); Mina Farah, Fountain Valley, CA (US)

(73) Assignee: Wyze Labs, Inc., Kirkland, WA (US)

(21) Appl. No.: 18/299,118

(22) Filed: Apr. 12, 2023

Related U.S. Application Data
(60) Provisional application No. 63/363,214, filed on Apr. 19, 2022.

(51) Int. Cl. H04W 12/75; H04W 12/08; H04W 12/037

(52) U.S. Cl. CPC H04W 12/08; H04W 12/037; H04W 12/75; H04W 84/18

(57) ABSTRACT

A system and method for enabling a new network access device to be automatically configured for integration with another existing wireless access device, or group of such devices They disclosed systems optionally uses vendor specific information passed between the devices which may be validated using a cloud based validation service. User input may be obtained verifying that the process of auto configuring the new device should continue. The information about the new and existing access devices may be encrypted, hashed, or otherwise obscured during the automatic configuration process to ensure authenticity. A temporary SSID may be used during the configuration process to avoid mixing normal network traffic with the configuration specific network traffic.

### CROSS-REFERENCE TO RELATED APPLICATION

This application claims the benefit of U.S. Provisional Application No. 63/363,214 filed Apr. 19, 2022 of which is hereby incorporated by reference.

### BACKGROUND

The present disclosure relates to automatic configuration procedures and techniques useful for Wi-Fi wireless access points, gateway devices, routers, and the like.

### SUMMARY

The disclosed system and method enables a new network access device to be automatically configured for integration with another existing wireless access device, or group of such devices. They disclosed systems optionally uses a private key signed vendor specific Information Elements (IE) in a WiFi Beacon/Probe response to help new device to validate the IE using a public key. In another aspect, the disclosed system includes optionally uses an enhanced Wireless Protected Setup (WPS) protocol to forward vendor specific IE, as well as information about the newly added network access device to a validation service. This validation service may operate on a computing platform remote from the new or existing network access devices, colloquially sometimes referred to as a “cloud based” system. For example, the existing network access devices may forward the new network device’s private key signed information to the validation service so that it can validate if this is device and return that result to the existing devices for further processing. In other aspect, the system may provide an opportunity to obtain user input indicating that the user agrees the new network access device should be added to the existing network access devices. This may, for example, be performed using an application executing on a remote computing device such as a smart phone, laptop computer, tablet computer, or any other suitable computing device. In another aspect, a dedicated provisioning SSID may be offered by the existing network access devices during a portion of the configuration procedure so that the new network access device may execute the configuration process without using the primary SSID presented by the existing network access devices 102. In this way, the system may advantageously avoid mixing normal network traffic with the configuration network traffic to reduce or eliminate the possibility of a network security breach.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a component diagram illustrating one example of a system and method for zero configuration Wi-Fi according to the present disclosure.

FIG. 2 is a sequence diagram illustrating one example of actions that may be taken by the system of FIG. 1.

### DETAILED DESCRIPTION

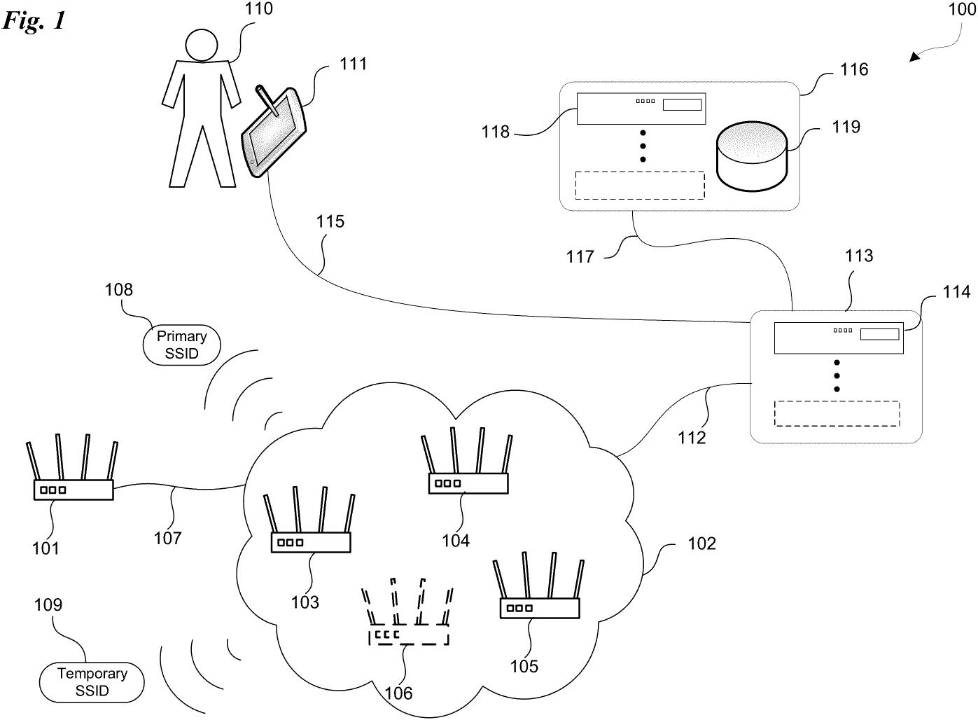

Illustrated in FIG. 1 at 100 is one example of components that may be included in the system of the present disclosure. A new network access device 101 may be ready to be automatically configured as part of a group of existing network access devices 102. The existing network access devices optionally includes one or more devices 103-106 which may be configured to operate as a Wi-Fi wireless network. These existing network access devices may be operable to function as single Network Access Device (NAD). For example, the devices 103-106 may implement a single logical network node with shared networking parameters thus forming a single service set with a single Service Set Identifier (SSID). This primary SSID 108 is optionally broadcast by the devices 103-106 thus notifying client devices that a connection is available irrespective of which of the individual devices 103-106 the client device is interacting with. The existing devices 102 may, when useful, broadcast a temporary SSID 109 that is different from the primary SSID. This temporary SSID may be used by the new access device 101 during one or more stages of the disclosed automatic configuration process.

In another aspect, the existing network access devices 102 may operate as a mesh network where the individual one or more devices 103-106 automatically maintain communication links between multiple others of the devices 103-106. The new network access device 101 may establish and maintain a communications link 107 with the existing devices 102 so that the new access device 101 may be automatically linked with the existing devices. The devices 101 and 102 may collaborate according to the disclosed method to automatically configure the new network access device 101 so that it may automatically become part of the existing service set with minimal manual input from a user 110. Such user input may be captured by a computing device 111 which may be any suitable computing device including, but not limited to, a smartphone, tablet, laptop computer, or desktop computer. The computing device 111 may include a processor, memory, and software modules configured to provide a user interface suitable for accepting input from the user 110. The user interface may be presented on a display device, and may include any suitable configuration of input devices for accepting input from the user 110.

In another aspect, the new device 101 may be configured to perform a scan procedure where the new device detects the presence of the existing network access devices 102, such as by looking for any available SSIDs. In another aspect, the new device 101 may include a control circuit that is configured or programmed to automatically initiate the scan procedure. In one example, the control circuit optionally triggers the scan procedure when the new device is powered on, but has yet to be linked to other wireless access devices 102. For example, when the new device 101 is first received from the factory, it may be configured to automatically scan for other devices when it is first powered on.

In another aspect, the control circuit of the new network access device may be configured to accept input from a user requesting that the scan procedure be performed. For example, the system may include, or be responsive to, a user interface provided by software executed on a computing device like the computing device 111, whereby user 110 may provide input which may be captured and sent to the new access device 101. The user may optionally initiate the scan to, for example, reset network settings on the new access device if the configuration of the network changes, or if the new access device was previously configured, and is later being moved to join a different set of collaborating network access devices.

In another aspect, the new access device 101 is optionally configurable to scan for SSIDs matching specific criteria. Such criteria may include logic or rules for determining whether the SSIDs found in the scanning procedure are suitable for automatic configuration. For example, the existing access devices 102 may be configured to provide information along with the SSID by which the new access device 101 may determine whether the automatic configuration process can proceed.

In one aspect, the existing access devices 102, may include one or more transmitter circuits configured to emit signals defining an Information Element (IE) that includes information about the existing access devices 102. The new access device 101 may include a receiver circuit configured to receive the signals provided by the transmitter circuit(s), and the receiver circuit may be responsive to those signals. Thus, the new access device 101 may be programmed or configured to determine the contents of the information element sent by the existing devices 102.

In another aspect, the information element optionally includes information about the service set such as the SSID. In another aspect, the IE transmitted by the existing devices 102 may include vendor specific information, and either the new access device 101, the existing access devices 102s, or both, may be programmed or configured with rules for determining if the new access device 101 is compatible with the existing access devices 102s in the service set.

In one example, the rules may be configured to compare the vendor specific information with one or more predetermined criteria useful for determining if the existing access devices 102s are operable to automatically link up with the new access device 101. In one aspect, the criteria may include comparing vendor specific information in the IE that includes, but is not limited to, the serial number, model number, and/or the Media Access Control address (MAC address) of the existing devices 102. This information may optionally be encrypted, hashed, or otherwise obfuscated so that only new access device 101s with corresponding authentication credentials, public or private keys, hash algorithms, and the like, may access the vendor specific information. The process of assembling the vendor specific information optionally occurs before or during the execution of the rule set.

In another aspect, the IE transmitted by the existing devices 102 may include information that is signed using a private key. This signing procedure may occur when the one or more existing access devices 103-106 are manufactured. The signing procedure may optionally occur any time after manufacture as part of an upgrade to the existing access devices 102. In another aspect, the private key may have been generated along with a corresponding public key. These two keys may constitute a public/private key pair generated according to specific criteria so that one of the keys in the pair may be stored in the existing network access devices 102, and the other key of the stored in the new network access device 102, and then both keys may be used to validate data passed between the network access devices 101 and 102.

In another aspect, the public key may be stored in a memory of the new network access device 102, and may optionally be saved to a memory when the new network access device 102 is manufactured, and/or at any other time after that using an update procedure. One criteria for determining the existing network devices will allow for automatic linking may be implemented by the new access device 101 where a processor of the new access device 101 executes a validation routine to determine if the vendor specific information is valid. If valid, the automatic linking process may continue. If not, the new access device 101 may halt the auto linking process and the new access device 101 may be configured to provide an error message, and/or options for proceeding with the manual process that includes accepting additional input from the user 110.

In another aspect of the automatic linking procedure, the new network access device 101 may be programmed and/or otherwise configured to send a probe request to the existing network access devices 102 in order to identify itself and request that the configuration process begin. This request optionally occurs after the new access device 101 has determined that the service set matches the criteria for automatic linking. The probe request may include data about the new access device 101 identifying aspects of the device that may be useful to the existing network access devices 102 in determining if automatic linking can proceed. In one example, the probe request includes a firmware version of the new access device 101. In another aspect, the probe request optionally includes the model number of the new access device 101, and/or optionally the Media Access Control address (MAC address) of the new access device 101. Any suitable data about the new access device 101 may be included in the probe request.

In another aspect, the data in the probe request may be encrypted, hashed, or otherwise obfuscated to protect it from unauthorized access. For example, the new access device 101 may encrypt the data using a private key of a public/private key pair, and the corresponding public key may be stored in a memory of the one or more of the existing network access devices 102. In another aspect, the data may be encrypted using a private key that is stored in both the new and the existing access devices. The new and existing access devices may thus include software modules, control logic, application specific hardware, or any combination thereof that is programmed or otherwise configured to hash, encrypt and/or decrypt, or otherwise obfuscate data passed between the new and existing network devices to facilitate a secure data exchange.

The existing access devices 102 may be programmed or configured with one or more processors or control circuitry for executing rules to decode, decrypt, or otherwise prepare the data from the probe request so that it may be compared with validation criteria. If the data in the probe request matches the validation criteria in the existing network access devices 102, the existing network access device may optionally send the data from the probe request, along with any other useful information about the network or the devices accessing it, to a validation service 113 via a communication link 112. The validation service 113 may be include one or more computing devices 114 having one or more processors, memory, control logic, and/or software modules (or any combination thereof) configured to validate whether the new device 101 is authentic and operable to automatically link to the existing devices 102. The validation service 113 may include its own authentication and validation rules that may be executed using the one or more processors to determine whether the new access device 101 is authorized to join with the existing devices in the service set.

In one aspect, if the validation service is optionally programmed or configured to determine whether the new access device 101 fails authentication, validation, or any combination thereof. The remote computing device may be optionally configured to save the information about the new access device 101 in a collection of data about devices that have been granted or denied access to the disclosed automatic configuration process. Accessing this data to determine if a new device is valid may be included as one of the validation criteria executed by the validation service 113. In another aspect, the information about the valid or invalid new access device 101 may be saved by the one or more devices of the existing network access devices 102 so that these devices may optionally update their own set of validation criteria. In this way subsequent attempts to link a suspicious new device 101 to the existing devices 102 may be halted earlier in the process either by the existing devices in the service set, or by the validation service 113.

In another aspect, the validation service 113 may optionally send information about the new network access device 101 to a remote computing device such as computing device 111 via a communication link 115. This action may take place, for example, after the validation service 113 has determined that the new network access device is valid and capable of being automatically linked with the existing access devices 102s. In one aspect, the validation service 113 may provide to the remote computing device at least a portion of the data about the new network access device 101. This data may include the model number, MAC address, or any other suitable information obtained by the validation service 113.

The remote computing device 111 may be configured to accept input from user 110 indicating whether the new device 101 is acceptable for installation in the service set with the existing network access devices 102. This input from the user may be passed to the validation service 113, which may in turn notify the existing network access devices 102 to proceed with the automatic configuration process. In another aspect, the remote computing device may optionally provide a binding token to be used by the new network access device 101. This token may be generated by the remote computing device 111 based on the identifying information retrieved from the new network access device 101. For example, the binding token may include a public or private key, or any combination thereof, or the token may be generated using a public or private key, a hash function, or other obfuscation routine.

In another aspect, the new network access device 101 may be bound to a user account maintained by an account service 116 accessible by the remote computing device via communication link 117. The account service may include one or more computing devices 119 in communication with an account database 119 that may include records relating information about users and the network access devices associated with those users. This database may be used where useful to verify the account associated with an existing or new network access device 102, or a new access device 101. For example, the remote computing device 111 may be configured to access the account service 116 to verify that the new network access device 101 is being configured by the user or entity associated with that device. For example, software executed by a processor of the remote computing device 111 may be configured to control the remote computing device to automatically obtain the account information from the account service 116 when the validation service 113 sends a message to the remote computing device confirming that the new network access device is ready for automatic configuration.

In one example of the automatic configuration procedure, the existing network devices 102 proceed with automatically initiate provisioning of the new network access device 101. In one aspect, the existing network access devices 102 may provide the new network access device with a temporary SSID 109 which may optionally include a user name and password randomly generated by the existing network device 102. In another aspect, the existing network access devices may activate or initiate Wireless Protected Setup (WPS) which may be used to pass the temporary SSID 109 to the new network access device 101.

In another aspect, the new network access device may proceed with the automatic configuration process by sending identifying information about the new access device 101 to the existing network devices. This may include the model number, MAC address, or other information about the new access device 101. Any suitable data about the new access device 101 may be included. In another aspect, the identifying information may be hashed, encrypted, or otherwise obfuscated before sending it so as to enhance the security of the configuration process. For example, the identifying information may be signed or encrypted using a public/private key pair, and the validation service may decrypt or validate the signed data using the public or private key from this key pair. This identifying data may be passed by the existing network devices 102 to the validation service 113. The validation service may determine whether the identifying information is valid according to one or more validation rules of the present disclosure.

The validation service 113 optionally provides a response indicating whether the existing network access devices 102 should proceed with provisioning the new network access device. The existing network devices 102 may respond to the new network access device 101 with information by which the new network device may join the existing service set. This information may include the primary SSID 108 of the existing network access devices 102, as well as corresponding access credentials associated with the SSID 108 such as a password, or other credentials. These credentials optionally include the binding token which may have been generated previously by the remote computing device 111. These credentials, optionally including the binding token, may be signed, encrypted, hashed, or otherwise obfuscated for security purposes such as by means of a public/private key pair, a private key, and the like. In another aspect, the new network access device may be configured to disconnect from the temporary SSID 109 and to connect to the primary SSID 108 that is used by the existing network devices 102.

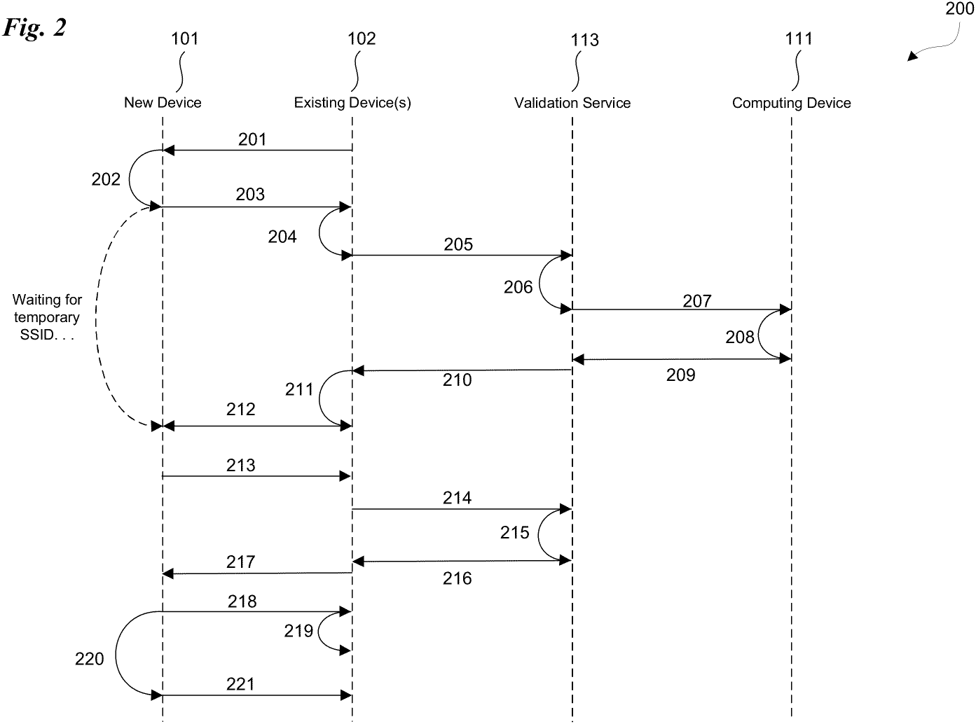

Illustrated in FIG. 2, at 200 is one example of the actions the system may take to implement the disclosed method of automatic configuration. At 201, the existing network access devices broadcast a signal defining vendor specific information about the existing network access devices that optionally includes data that was signed using a private key when the device was first produced. The data provided using this broadcast may be encrypted using a private key, or a public/private key pair. At 202, the new network access device may use a public key stored in a memory of the new device to validate whether the existing network access devices are operable for automatic configuration.

If so, the new device 101 sends a probe request at 203 to the existing devices 102 with vendor and product specific information such as a model number and MAC address of the new device. This request is optionally signed by a private key stored in the new device. The existing devices 102 receive the probe request and determine whether it includes the required vendor and/or product specific information at 204.

The payload of data received from the new device 101 is optionally forwarded to the validation service 113 at 205. At 206, the validation service optionally uses a public key to decrypt or otherwise validate the payload is from a product that is operable to perform the auto configuration process.

At 207, at least a portion of the information about the new access device 101 that was provided in the payload may be forwarded to the computing device 111 thus allowing the user to confirm/deny that the new device should be allowed to proceed with auto configuration. The user may provide input confirming that the process should move forward at 208. The computing device 111 may then send a response at 209 that may include the primary SSID, and the password, along with an optional binding token which may be generated by the computing device 111.

The response may be passed through from the validation service at 210 to the current network access devices that initially requested validation at 204. The current devices 102 may activate a temporary SSID and the Wireless Protected Setup (WPS) services at 211. The WPS handshaking process may proceed at 212, and information about the new access device may be provided to the existing access devices at 213. This identifying information may also be encrypted or signed to ensure authenticity and reduce or eliminate unauthorized access.

The existing devices may request validation of the information at 214, and the validating service may make the determination that the new device is valid at 215. Here again, the data may be obfuscated, signed, hashed, or encrypted to ensure authentication and security. A response is sent to the existing devices 102 at 216, and if the validation passed, the existing devices optionally send the primary SSID, password, and binding token to the new access device at 217. This SSID, password, and binding token may be hashed or encrypted using a private key known to both the new and existing devices, or using a public/private key pair.

Upon successful receipt of the primary SSID at 217, the new access device 101 optionally disconnects the WPS connection at 218 that was first activated at 212. The existing devices 102 may then deactivate the temporary SSID at 219, and the new device may switch to the existing network using the primary SSID at 220. The new connection may be initiated at 221, and the remaining aspects of the configuration process may proceed using the binding key.

The concepts illustrated and disclosed herein related to a system and method for zero configuration Wi-Fi according to the present disclosure may be arranged and configured according to any of the following non-limiting numbered examples:

Example 1: A method, that includes receiving device information from a new network access device, determining that the device information is valid, sending access parameters from an existing network access device to the new network access device, and configuring the new network access device to operate together with the existing network devices.

Example 2: The method of any other example, wherein the device information from the new network access device is obtained using one or more existing network access devices.

Example 3: The method of any other example, wherein the network includes one or more existing network access devices that are arranged and configured to operate as a single logical network segment.

Example 4: The method of any other example, comprising using a validation service accessible by the one or more existing network access devices via a communication link to determine that the device information is valid.

Example 5: The method of any other example, wherein the device information is encrypted.

Example 6: The method of any other example, wherein the device information includes a firmware version, model name and/or number, and a MAC address, or any combination thereof.

Example 7: The method of any other example, comprising broadcasting a vendor specific information element from the existing network access devices.

Example 8: The method of any other example, wherein an information element broadcast by existing network access devices includes a serial number, model name and/or number, MAC address, or any combination thereof.

Example 9: The method of any other example, wherein an information element broadcast by existing network access devices is encrypted.

Example 10: The method of any other example, comprising sending vendor specific information about the new or existing network access devices to a validation service accessible by existing network access devices to determine that the device information is valid.

Example 11: The method of any other example, comprising receiving user input from a remote computing device confirming that the new device should be configured to operate with the existing devices.

Example 12: The method of any other example, comprising generating a binding key specific to the new access device and an existing access devices.

Example 13: The method of any other example, comprising activating a temporary SSID provided by existing network access devices.

Example 14: The method of any other example, comprising activating a WPS communication link between the new and existing access devices.

Example 15: The method of any other example, comprising sending a primary SSID from an existing access devices to the new access device.

Example 16: The method of any other example, comprising connecting the new access device to existing access devices using a primary SSID that is different from a temporary SSID.

Example 17: The method of any other example, comprising encrypting a primary SSID and password before sending the primary SSID from existing network access devices to the new network access device.

Example 18: The method of any other example, comprising deactivating a temporary SSID.

Example 19: The method of any other example, wherein determining that the device information is valid includes using a public key to validate that the new access device is operable to operate in conjunction with existing network access devices.

Example 20: The method of any other example, wherein existing network access devices are arranged and configured to operate as a mesh network.

Example 21: The method of any other example, comprising associating a new network access device with a user account maintained by an account service.

Example 22: The method of any other example, wherein a temporary SSID is generated by existing network access devices, and wherein the temporary SSID is generated randomly.

Example 23: The method of any other example, wherein configuring the new network access device includes integrating the new network access devices to operate along with existing access devices as part of a single logical network segment.

### Glossary of Definitions and Alternatives

While the invention is illustrated in the drawings and described herein, this disclosure is to be considered as illustrative and not restrictive in character. The present disclosure is exemplary in nature and all changes, equivalents, and modifications that come within the spirit of the invention are included. The detailed description is included herein to discuss aspects of the examples illustrated in the drawings for the purpose of promoting an understanding of the principles of the invention. No limitation of the scope of the invention is thereby intended. Any alterations and further modifications in the described examples, and any further applications of the principles described herein are contemplated as would normally occur to one skilled in the art to which the invention relates. Some examples are disclosed in detail, however some features that may not be relevant may have been left out for the sake of clarity.

Where there are references to publications, patents, and patent applications cited herein, they are understood to be incorporated by reference as if each individual publication, patent, or patent application were specifically and individually indicated to be incorporated by reference and set forth in its entirety herein.

Singular forms “a”, “an”, “the”, and the like include plural referents unless expressly discussed otherwise. As an illustration, references to “a device” or “the device” include one or more of such devices and equivalents thereof.

Directional terms, such as “up”, “down”, “top” “bottom”, “fore”, “aft”, “lateral”, “longitudinal”, “radial”, “circumferential”, etc., are used herein solely for the convenience of the reader in order to aid in the reader’s understanding of the illustrated examples. The use of these directional terms does not in any manner limit the described, illustrated, and/or claimed features to a specific direction and/or orientation.

Multiple related items illustrated in the drawings with the same part number which are differentiated by a letter for separate individual instances, may be referred to generally by a distinguishable portion of the full name, and/or by the number alone. For example, if multiple “laterally extending elements” 90A, 90B, 90C, and 90D are illustrated in the drawings, the disclosure may refer to these as “laterally extending elements 90A-90D,” or as “laterally extending elements 90,” or by a distinguishable portion of the full name such as “elements 90”.

The language used in the disclosure are presumed to have only their plain and ordinary meaning, except as explicitly defined below. The words used in the definitions included herein are to only have their plain and ordinary meaning. Such plain and ordinary meaning is inclusive of all consistent dictionary definitions from the most recently published Webster’s and Random House dictionaries. As used herein, the following definitions apply to the following terms or to common variations thereof (e.g., singular/plural forms, past/present tenses, etc.):

“About” with reference to numerical values generally refers to plus or minus 10% of the stated value. For example, if the stated value is 4.375, then use of the term “about 4.375” generally means a range between 3.9375 and 4.8125.

“Activate” generally is synonymous with “providing power to”, or refers to “enabling a specific function” of a circuit or electronic device that already has power.

“And/or” is inclusive here, meaning “and” as well as “or”. For example, “P and/or Q” encompasses, P, Q, and P with Q; and, such “P and/or Q” may include other elements as well.

“Antenna” or “Antenna system” generally refers to an electrical device, or series of devices, in any suitable configuration, that converts electric power into electromagnetic radiation. Such radiation may be either vertically, horizontally, or circularly polarized at any frequency along the electromagnetic spectrum. Antennas transmitting with circular polarity may have either right-handed or left-handed polarization.

In the case of radio waves, an antenna may transmit at frequencies ranging along electromagnetic spectrum from extremely low frequency (ELF) to extremely high frequency (EHF). An antenna or antenna system designed to transmit radio waves may comprise an arrangement of metallic conductors (elements), electrically connected (often through a transmission line) to a receiver or transmitter. An oscillating current of electrons forced through the antenna by a transmitter can create an oscillating magnetic field around the antenna elements, while the charge of the electrons also creates an oscillating electric field along the elements. These time-varying fields radiate away from the antenna into space as a moving transverse electromagnetic field wave. Conversely, during reception, the oscillating electric and magnetic fields of an incoming electromagnetic wave exert force on the electrons in the antenna elements, causing them to move back and forth, creating oscillating currents in the antenna. These currents can then be detected by receivers and processed to retrieve digital or analog signals or data.

Antennas can be designed to transmit and receive radio waves substantially equally in all horizontal directions (omnidirectional antennas), or preferentially in a particular direction (directional or high gain antennas). In the latter case, an antenna may also include additional elements or surfaces which may or may not have any physical electrical connection to the transmitter or receiver. For example, parasitic elements, parabolic reflectors or horns, and other such non-energized elements serve to direct the radio waves into a beam or other desired radiation pattern. Thus antennas may be configured to exhibit increased or decreased directionality or “gain” by the placement of these various surfaces or elements. High gain antennas can be configured to direct a substantially large portion of the radiated electromagnetic energy in a given direction that may be vertical horizontal or any combination thereof.

Antennas may also be configured to radiate electromagnetic energy within a specific range of vertical angles (i.e. “takeoff angles”) relative to the earth in order to focus electromagnetic energy toward an upper layer of the atmosphere such as the ionosphere. By directing electromagnetic energy toward the upper atmosphere at a specific angle, specific skip distances may be achieved at particular times of day by transmitting electromagnetic energy at particular frequencies.

Other examples of antennas include emitters and sensors that convert electrical energy into pulses of electromagnetic energy in the visible or invisible light portion of the electromagnetic spectrum. Examples include light emitting diodes, lasers, and the like that are configured to generate electromagnetic energy at frequencies ranging along the electromagnetic spectrum from far infrared to extreme ultraviolet.

“Controller” or “control circuit” generally refers to a mechanical or electronic device configured to control the behavior of another mechanical or electronic device. A controller or “control circuit” is optionally configured to provide signals or other electrical impulses that may be received and interpreted by the controlled device to indicate how it should behave.

“Communication Link” generally refers to a connection between two or more communicating entities and may or may not include a communications channel between the communicating entities. The communication between the communicating entities may occur by any suitable means. For example the connection may be implemented as an actual physical link, an electrical link, an electromagnetic link, a logical link, or any other suitable linkage facilitating communication.

In the case of an actual physical link, communication may occur by multiple components in the communication link configured to respond to one another by physical movement of one element in relation to another. In the case of an electrical link, the communication link may be composed of multiple electrical conductors electrically connected to form the communication link.

In the case of an electromagnetic link, the connection may be implemented by sending or receiving electromagnetic energy at any suitable frequency, thus allowing communications to pass as electromagnetic waves. These electromagnetic waves may or may not pass through a physical medium such as an optical fiber, or through free space, or any combination thereof. Electromagnetic waves may be passed at any suitable frequency including any frequency in the electromagnetic spectrum.

A communication link may include any suitable combination of hardware which may include software components as well. Such hardware may include routers, switches, networking endpoints, repeaters, signal strength enters, hubs, and the like.

In the case of a logical link, the communication link may be a conceptual linkage between the sender and recipient such as a transmission station in the receiving station. Logical link may include any combination of physical, electrical, electromagnetic, or other types of communication links.

“Computer” generally refers to any computing device configured to compute a result from any number of input values or variables. A computer may include a processor for performing calculations to process input or output. A computer may include a memory for storing values to be processed by the processor, or for storing the results of previous processing.

A computer may also be configured to accept input and output from a wide array of input and output devices for receiving or sending values. Such devices include other computers, keyboards, mice, visual displays, printers, industrial equipment, and systems or machinery of all types and sizes. For example, a computer can control a network or network interface to perform various network communications upon request. The network interface may be part of the computer, or characterized as separate and remote from the computer.

A computer may be a single, physical, computing device such as a desktop computer, a laptop computer, or may be composed of multiple devices of the same type such as a group of servers operating as one device in a networked cluster, or a heterogeneous combination of different computing devices operating as one computer and linked together by a communication network. The communication network connected to the computer may also be connected to a wider network such as the internet. Thus, a computer may include one or more physical processors or other computing devices or circuitry, and may also include any suitable type of memory.

A computer may also be a virtual computing platform having an unknown or fluctuating number of physical processors and memories or memory devices. A computer may thus be physically located in one geographical location or physically spread across several widely scattered locations with multiple processors linked together by a communication network to operate as a single computer.

The concept of “computer” and “processor” within a computer or computing device also encompasses any such processor or computing device serving to make calculations or comparisons as part of the disclosed system. Processing operations related to threshold comparisons, rules comparisons, calculations, and the like occurring in a computer may occur, for example, on separate servers, the same server with separate processors, or on a virtual computing environment having an unknown number of physical processors as described above.

A computer may be optionally coupled to one or more visual displays and/or may include an integrated visual display. Likewise, displays may be of the same type, or a heterogeneous combination of different visual devices. A computer may also include one or more operator input devices such as a keyboard, mouse, touch screen, laser or infrared pointing device, or gyroscopic pointing device to name just a few representative examples. Also, besides a display, one or more other output devices may be included such as a printer, plotter, industrial manufacturing machine, 3D printer, and the like. As such, various display, input and output device arrangements are possible.

Multiple computers or computing devices may be configured to communicate with one another or with other devices over wired or wireless communication links to form a network. Network communications may pass through various computers operating as network appliances such as switches, routers, firewalls or other network devices or interfaces before passing over other larger computer networks such as the internet. Communications can also be passed over the network as wireless data transmissions carried over electromagnetic waves through transmission lines or free space. Such communications include using WiFi or other Wireless Local Area Network (WLAN) or a cellular transmitter/receiver to transfer data.

“Data” generally refers to one or more values of qualitative or quantitative variables that are usually the result of measurements. Data may be considered “atomic” as being finite individual units of specific information. Data can also be thought of as a value or set of values that includes a frame of reference indicating some meaning associated with the values. For example, the number “2” alone is a symbol that absent some context is meaningless. The number “2” may be considered “data” when it is understood to indicate, for example, the number of items produced in an hour.

Data may be organized and represented in a structured format. Examples include a tabular representation using rows and columns, a tree representation with a set of nodes considered to have a parent-children relationship, or a graph representation as a set of connected nodes to name a few.

The term “data” can refer to unprocessed data or “raw data” such as a collection of numbers, characters, or other symbols representing individual facts or opinions. Data may be collected by sensors in controlled or uncontrolled environments, or generated by observation, recording, or by processing of other data. The word “data” may be used in a plural or singular form. The older plural form “datum” may be used as well.

“Database” also referred to as a “data store”, “data repository”, or “knowledge base” generally refers to an organized collection of data. The data is typically organized to model aspects of the real world in a way that supports processes obtaining information about the world from the data. Access to the data is generally provided by a “Database Management System” (DBMS) consisting of an individual computer software program or organized set of software programs that allow user to interact with one or more databases providing access to data stored in the database (although user access restrictions may be put in place to limit access to some portion of the data). The DBMS provides various functions that allow entry, storage and retrieval of large quantities of information as well as ways to manage how that information is organized. A database is not generally portable across different DBMSs, but different DBMSs can interoperate by using standardized protocols and languages such as Structured Query Language (SQL), Open Database Connectivity (ODBC), Java Database Connectivity (JDBC), or Extensible Markup Language (XML) to allow a single application to work with more than one DBMS.

Databases and their corresponding database management systems are often classified according to a particular database model they support. Examples include a DBMS that relies on the “relational model” for storing data, usually referred to as Relational Database Management Systems (RDBMS). Such systems commonly use some variation of SQL to perform functions which include querying, formatting, administering, and updating an RDBMS. Other examples of database models include the “object” model, chained model (such as in the case of a “blockchain” database), the “object-relational” model, the “file”, “indexed file” or “flat-file” models, the “hierarchical” model, the “network” model, the “document” model, the “XML” model using some variation of XML, the “entity-attribute-value” model, and others.

Examples of commercially available database management systems include PostgreSQL provided by the PostgreSQL Global Development Group; Microsoft SQL Server provided by the Microsoft Corporation of Redmond, Washington, USA; MySQL and various versions of the Oracle DBMS, often referred to as simply “Oracle” both separately offered by the Oracle Corporation of Redwood City, California, USA; the DBMS generally referred to as “SAP” provided by SAP SE of Walldorf, Germany; and the D22 DBMS provided by the International Business Machines Corporation (IBM) of Armonk, New York, USA.

The database and the DBMS software may also be referred to collectively as a “database”. Similarly, the term “database” may also collectively refer to the database, the corresponding DBMS software, and a physical computer or collection of computers. Thus the term “database” may refer to the data, software for managing the data, and/or a physical computer that includes some or all of the data and/or the software for managing the data.

“Display device” generally refers to any device capable of being controlled by an electronic circuit or processor to display information in a visual or tactile. A display device may be configured as an input device taking input from a user or other system (e.g. a touch sensitive computer screen), or as an output device generating visual or tactile information, or the display device may configured to operate as both an input or output device at the same time, or at different times.

The output may be two-dimensional, three-dimensional, and/or mechanical displays and includes, but is not limited to, the following display technologies: Cathode ray tube display (CRT), Light-emitting diode display (LED), Electroluminescent display (ELD), Electronic paper, Electrophoretic Ink (E-ink), Plasma display panel (PDP), Liquid crystal display (LCD), High-Performance Addressing display (HPA), Thin-film transistor display (TFT), Organic light-emitting diode display (OLED), Surface-conduction electron-emitter display (SED), Laser TV, Carbon nanotubes, Quantum dot display, Interferometric modulator display (IMOD), Swept-volume display, Varifocal mirror display, Emissive volume display, Laser display, Holographic display, Light field displays, Volumetric display, Ticker tape, Split-flap display, Flip-disc display (or flip-dot display), Rollsign, mechanical gauges with moving needles and accompanying indicia, Tactile electronic displays (aka refreshable Braille display), Optacon displays, or any devices that either alone or in combination are configured to provide visual feedback on the status of a system, such as the “check engine” light, a “low altitude” warning light, an array of red, yellow, and green indicators configured to indicate a temperature range.

“Electrically connected” generally refers to a configuration of two objects that allows electricity to flow between them or through them. In one example, two conductive materials are physically adjacent one another and are sufficiently close together so that electricity can pass between them. In another example, two conductive materials are in physical contact allowing electricity to flow between them.

“Input Device” generally refers to any device coupled to a computer that is configured to receive input and deliver the input to a processor, memory, or other part of the computer. Such input devices can include keyboards, mice, trackballs, touch sensitive pointing devices such as touchpads, or touchscreens. Input devices also include any sensor or sensor array for detecting environmental conditions such as temperature, light, noise, vibration, humidity, and the like.

“Information Element” generally refers to a field, or group of fields, sent between a base transceiver station of a wireless network and a remote computing device. An information element may include an identifier, a length indicator, and a value, although any combination of one or more of those parts is possible. Examples of fields that may be included in an information element of the present disclosure include, but are not limited to, an SSID, supported data rates, frequency hopping parameters, direct sequence parameters, content free parameters, independent basic service set parameters, country parameters, frequency hopping pattern parameters, frequency hopping pattern tables, power constraints, power capabilities, and vendor specific parameters that may include values specific to the operation of the base station or interoperability between the base station and other base stations, or between the base station and other computing devices seeking to create and maintain a wireless connection with the base station.

“Memory” generally refers to any storage system or device configured to retain data or information. Each memory may include one or more types of solid-state electronic memory, magnetic memory, or optical memory, just to name a few. Memory may use any suitable storage technology, or combination of storage technologies, and may be volatile, nonvolatile, or a hybrid combination of volatile and nonvolatile varieties. By way of non-limiting example, each memory may include solid-state electronic Random Access Memory (RAM), Sequentially Accessible Memory (SAM) (such as the First-In, First-Out (FIFO) variety or the Last-In-First-Out (LIFO) variety), Programmable Read Only Memory (PROM), Electronically Programmable Read Only Memory (EPROM), or Electrically Erasable Programmable Read Only Memory (EEPROM).

Memory can refer to Dynamic Random Access Memory (DRAM) or any variants, including static random access memory (SRAM), Burst SRAM or Synch Burst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (REDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM).

Memory can also refer to non-volatile storage technologies such as non-volatile read access memory (NVRAM), flash memory, non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Domain Wall Memory (DWM) or “Racetrack” memory, Nano-RAM (NRAM), or Millipede memory. Other non-volatile types of memory include optical disc memory (such as a DVD or CD ROM), a magnetically encoded hard disc or hard disc platter, floppy disc, tape, or cartridge media. The concept of a “memory” includes the use of any suitable storage technology or any combination of storage technologies.

“Mesh Network” generally refers to a local network topology in which individual network infrastructure nodes such as bridges, switches, and other infrastructure devices connect via communication links directly to multiple other nodes to efficiently route data between client devices accessing the network. The communication links between nodes may be established and maintained dynamically, and the devices may be configured to automatically organize and configure themselves in concert which can reduce installation overhead

In another aspect, dives in a mesh network may be linked together non-hierarchically. This lack of dependency on one or two central nodes allows every node to participate in the relay of information. It may also increase the fault tolerance of the network as the ability of nodes in the network to automatically reconfigure themselves to route traffic away from another node on the network that has failed, or is operating at a low level. By contrast, in more conventional “star” or “tree” local network topologies, the bridges/switches and other network nodes may be directly linked via communications links to only a small subset of other nodes. In many instances, the communication links between neighboring infrastructure nodes are more hierarchical. Thus a failure of any one node may have a much greater impact on the overall ability of the network to perform as required.

“Module” or “Engine” generally refers to a collection of computational or logic circuits implemented in hardware, or to a series of logic or computational instructions expressed in executable, object, or source code, or any combination thereof, configured to perform tasks or implement processes. A module may be implemented in software maintained in volatile memory in a computer and executed by a processor or other circuit. A module may be implemented as software stored in an erasable/programmable nonvolatile memory and executed by a processor or processors. A module may be implanted as software coded into an Application Specific Information Integrated Circuit (ASIC). A module may be a collection of digital or analog circuits configured to control a machine to generate a desired outcome.

Modules may be executed on a single computer with one or more processors, or by multiple computers with multiple processors coupled together by a network. Separate aspects, computations, or functionality performed by a module may be executed by separate processors on separate computers, by the same processor on the same computer, or by different computers at different times.

“Multiple” as used herein is synonymous with the term “plurality” and refers to more than one, or by extension, two or more.

“Network” or “Computer Network” generally refers to a telecommunications network that allows computers to exchange data. Computers can pass data to each other along data connections by transforming data into a collection of datagrams or packets. The connections between computers and the network may be established using either cables, optical fibers, or via electromagnetic transmissions such as for wireless network devices.

Computers coupled to a network may be referred to as “nodes” or as “hosts” and may originate, broadcast, route, or accept data from the network. Nodes can include any computing device such as personal computers, phones, servers as well as specialized computers that operate to maintain the flow of data across the network, referred to as “network devices”. Two nodes can be considered “networked together” when one device is able to exchange information with another device, whether or not they have a direct connection to each other.

Examples of wired network connections may include Digital Subscriber Lines (DSL), coaxial cable lines, or optical fiber lines. The wireless connections may include BLUETOOTH, Worldwide Interoperability for Microwave Access (WiMAX), infrared channel or satellite band, or any wireless local area network (Wi-Fi) such as those implemented using the Institute of Electrical and Electronics Engineers′ (IEEE) 802.11 standards (e.g. 802.11(a), 802.11(b), 802.11(g), or 802.11(n) to name a few). Wireless links may also include or use any cellular network standards used to communicate among mobile devices including 1G, 2G, 3G, or 4G. The network standards may qualify as 1G, 2G, etc. by fulfilling a specification or standards such as the specifications maintained by International Telecommunication Union (ITU). For example, a network may be referred to as a “3G network” if it meets the criteria in the International Mobile Telecommunications-2000 (IMT-2000) specification regardless of what it may otherwise be referred to. A network may be referred to as a “4G network” if it meets the requirements of the International Mobile Telecommunications Advanced (IMTAdvanced) specification. Examples of cellular network or other wireless standards include AMPS, GSM, GPRS, UMTS, LTE, LTE Advanced, Mobile WiMAX, and WiMAX-Advanced.

Cellular network standards may use various channel access methods such as FDMA, TDMA, CDMA, or SDMA. Different types of data may be transmitted via different links and standards, or the same types of data may be transmitted via different links and standards.

The geographical scope of the network may vary widely. Examples include a body area network (BAN), a personal area network (PAN), a low power wireless Personal Area Network using IPv6 (6LoWPAN), a local-area network (LAN), a metropolitan area network (MAN), a wide area network (WAN), or the Internet.

A network may have any suitable network topology defining the number and use of the network connections. The network topology may be of any suitable form and may include point-to-point, bus, star, ring, mesh, or tree. A network may be an overlay network which is virtual and is configured as one or more layers that use or “lay on top of” other networks.

A network may utilize different communication protocols or messaging techniques including layers or stacks of protocols. Examples include the Ethernet protocol, the internet protocol suite (TCP/IP), the ATM (Asynchronous Transfer Mode) technique, the SONET (Synchronous Optical Networking) protocol, or the SDE1 (Synchronous Digital Elierarchy) protocol. The TCP/IP internet protocol suite may include application layer, transport layer, internet layer (including, e.g., IPv6), or the link layer.

“Network Access device (NAD)” generally refers to a physical device, or a collection of physical devices, that individual or together are operable to establish and maintain a network connection between a client device and a computer network. This network connection may be established or maintained via a wired, wireless, or other suitable communication link. In another aspect an NAD may have the ability to report power failures and automatically reconnect themselves if a connection to the client, and/or the computer network is lost.

In one example, in the context of a broadband internet connection, an NAD includes physical equipment required to make a connection to a Wide Area Network (WAN) from a Local Area Network (LAN). In this example, the NAD may include a router, modem and a power supply.

In another example, in the context of a LAN, an NAD may include, but is not limited to, wireless access points, wireless routers, or wired switches, routers, bridges, and the like.

“Optionally” as used herein means discretionary; not required; possible, but not compulsory; left to personal choice.

“Output Device” generally refers to any device or collection of devices that is controlled by computer to produce an output. This includes any system, apparatus, or equipment receiving signals from a computer to control the device to generate or create some type of output. Examples of output devices include, but are not limited to, screens or monitors displaying graphical output, any projector a projecting device projecting a two-dimensional or three-dimensional image, any kind of printer, plotter, or similar device producing either two-dimensional or three-dimensional representations of the output fixed in any tangible medium (e.g. a laser printer printing on paper, a lathe controlled to machine a piece of metal, or a three-dimensional printer producing an object). An output device may also produce intangible output such as, for example, data stored in a database, or electromagnetic energy transmitted through a medium or through free space such as audio produced by a speaker controlled by the computer, radio signals transmitted through free space, or pulses of light passing through a fiber-optic cable.

“Personal computing device” generally refers to a computing device configured for use by individual people. Examples include mobile devices such as Personal Digital Assistants (PDAs), tablet computers, wearable computers installed in items worn on the human body such as in eye glasses, watches, laptop computers, portable music/video players, computers in automobiles, or cellular telephones such as smart phones. Personal computing devices can be devices that are typically not mobile such as desk top computers, game consoles, or server computers. Personal computing devices may include any suitable input/output devices and may be configured to access a network such as through a wireless or wired connection, and/or via other network hardware.

“Portion” means a part of a whole, either separated from or integrated with it.

“Predominately” as used herein is synonymous with greater than 50%.

“Processor” generally refers to one or more electronic components configured to operate as a single unit configured or programmed to process input to generate an output. Alternatively, when of a multi-component form, a processor may have one or more components located remotely relative to the others. One or more components of each processor may be of the electronic variety defining digital circuitry, analog circuitry, or both. In one example, each processor is of a conventional, integrated circuit microprocessor arrangement, such as one or more PENTIUM, i3, i5 or i7 processors supplied by INTEL Corporation of Santa Clara, California, USA. Other examples of commercially available processors include but are not limited to the X8 and Freescale Coldfire processors made by Motorola Corporation of Schaumburg, Illinois, USA; the ARM processor and TEGRA System on a Chip (SoC) processors manufactured by Nvidia of Santa Clara, California, USA; the POWER7 processor manufactured by International Business Machines of White Plains, New York, USA; any of the FX, Phenom, Athlon, Sempron, or Opteron processors manufactured by Advanced Micro Devices of Sunnyvale, California, USA; or the Snapdragon SoC processors manufactured by Qalcomm of San Diego, California, USA.

A processor also includes Application-Specific Integrated Circuit (ASIC). An ASIC is an Integrated Circuit (IC) customized to perform a specific series of logical operations is controlling a computer to perform specific tasks or functions. An ASIC is an example of a processor for a special purpose computer, rather than a processor configured for general-purpose use. An application-specific integrated circuit generally is not reprogrammable to perform other functions and may be programmed once when it is manufactured.

In another example, a processor may be of the “field programmable” type. Such processors may be programmed multiple times “in the field” to perform various specialized or general functions after they are manufactured. A field-programmable processor may include a Field-Programmable Gate Array (FPGA) in an integrated circuit in the processor. FPGA may be programmed to perform a specific series of instructions which may be retained in nonvolatile memory cells in the FPGA. The FPGA may be configured by a customer or a designer using a hardware description language (HDL). In FPGA may be reprogrammed using another computer to reconfigure the FPGA to implement a new set of commands or operating instructions. Such an operation may be executed in any suitable means such as by a firmware upgrade to the processor circuitry.

Just as the concept of a computer is not limited to a single physical device in a single location, so also the concept of a “processor” is not limited to a single physical logic circuit or package of circuits but includes one or more such circuits or circuit packages possibly contained within or across multiple computers in numerous physical locations. In a virtual computing environment, an unknown number of physical processors may be actively processing data, the unknown number may automatically change over time as well.

The concept of a “processor” includes a device configured or programmed to make threshold comparisons, rules comparisons, calculations, or perform logical operations applying a rule to data yielding a logical result (e.g. “true” or “false”). Processing activities may occur in multiple single processors on separate servers, on multiple processors in a single server with separate processors, or on multiple processors physically remote from one another in separate computing devices.

“Receive” generally refer system be sent to the monitoring system s to accepting something transferred, communicated, conveyed, relayed, dispatched, or forwarded. The concept may or may not include the act of listening or waiting for something to arrive from a transmitting entity. For example, a transmission may be received without knowledge as to who or what transmitted it. Likewise the transmission may be sent with or without knowledge of who or what is receiving it. To “receive” may include, but is not limited to, the act of capturing or obtaining electromagnetic energy at any suitable frequency in the electromagnetic spectrum. Receiving may occur by sensing electromagnetic radiation. Sensing electromagnetic radiation may involve detecting energy waves moving through or from a medium such as a wire or optical fiber. Receiving includes receiving digital signals which may define various types of analog or binary data such as signals, datagrams, packets and the like.

“Receiver” generally refers to a device configured to receive, for example, digital or analog signals carrying information via electromagnetic energy. A receiver using electromagnetic energy may operate with an antenna or antenna system to intercept electromagnetic waves passing through a medium such as air, a conductor such as a metallic cable, or through glass fibers. A receiver can be a separate piece of electronic equipment, or an electrical circuit within another electronic device. A receiver and a transmitter combined in one unit are called a “transceiver”.

A receiver may use electronic circuits configured to filter or separate one or more desired radio frequency signals from all the other signals received by the antenna, an electronic amplifier to increase the power of the signal for further processing, and circuits configured to demodulate the information received.

Examples of the information received include sound (an audio signal), images (a video signal) or data (a digital signal). Devices that contain radio receivers include television sets, radar equipment, two-way radios, cell phones and other cellular devices, wireless computer networks, GPS navigation devices, radio telescopes, Bluetooth enabled devices, garage door openers, and/or baby monitors.

“Rule” generally refers to a conditional statement with at least two outcomes. A rule may be compared to available data which can yield a positive result (all aspects of the conditional statement of the rule are satisfied by the data), or a negative result (at least one aspect of the conditional statement of the rule is not satisfied by the data). One example of a rule is shown below as pseudo code of an “if/then/else” statement that may be coded in a programming language and executed by a processor in a computer:

if(clouds.areGrey() and
(clouds.numberOfClouds > 100)) then {
prepare for rain;
} else {
Prepare for sunshine;
}

“Service Set” generally refers to a logical network of nodes operating with shared link-layer networking parameters. Thus a service set forms a single logical network segment. A service set may be implemented physically using one or more computing devices configured to interact via wired or wireless communications links to appear as a single logical network node. Thus a computing device seeking to interact with this single network node may do so via a wireless network connection irrespective of the number of computing devices used to implement the logical node.

“Service Set Identifier (SSID)” generally refers to information that defines a service set. An SSID may be broadcast via wireless communication links and may include data that is useful for announcing the presence of a network, and an identifier or “name” by which computers seeking to establish a wireless communication link with the network may distinguish one service set from another. SSIDs are optionally customizable and may be of any suitable length with any suitable format of data elements or fields.

“Signal” generally refers to a function or means of representing information. It may be thought of as the output of a transformation or encoding process. The concept generally includes a change in the state of a medium or carrier that conveys the information. The medium can be any suitable medium such as air, water, electricity, magnetism, or electromagnetic energy such as in the case of radio waves, pulses of visible or invisible light, and the like.

As used herein, a “signal” implies a representation of meaningful information. Arbitrary or random changes in the state of a carrier medium are generally not considered “signals” and may be considered “noise”. For example, arbitrary binary data streams are not considered as signals. On the other hand, analog and digital signals that are representations of analog physical quantities are examples of signals. A signal is commonly not useful without some way to transmit or send the information, and a receiver responsive to the transmitter for receiving the information.

In a communication system, for example, a transmitter encodes a message to a signal, which is carried to a receiver by the communications channel. For example, the words “The time is 12 o′clock” might be the message spoken into a telephone. The telephone transmitter may then convert the sounds into an electrical voltage signal. The signal is transmitted to the receiving telephone by wires, at the receiver it is reconverted into sounds.

Signals may be thought of as “discrete” or “continuous.” Discrete-time signals are often referred to as time series in other fields. Continuous-time signals are often referred to as continuous signals even when the signal functions are not continuous, such as in a square-wave signal.

Another categorization is signals which are “discrete-valued” and “continuous-valued”. Particularly in digital signal processing a digital signal is sometimes defined as a sequence of discrete values, that may or may not be derived from an underlying continuous-valued physical process. In other contexts, digital signals are defined as the continuous-time waveform signals in a digital system, representing a bit-stream. In the first case, a signal that is generated by means of a digital modulation method may be considered as converted to an analog signal, while it may be considered as a digital signal in the second case.

“Transmit” generally refers to causing something to be transferred, communicated, conveyed, relayed, dispatched, or forwarded. The concept may or may not include the act of conveying something from a transmitting entity to a receiving entity. For example, a transmission may be received without knowledge as to who or what transmitted it. Likewise the transmission may be sent with or without knowledge of who or what is receiving it. To “transmit” may include, but is not limited to, the act of sending or broadcasting electromagnetic energy at any suitable frequency in the electromagnetic spectrum. Transmissions may include digital signals which may define various types of binary data such as datagrams, packets and the like. A transmission may also include analog signals.

Information such as a signal provided to the transmitter may be encoded or modulated by the transmitter using various digital or analog circuits. The information may then be transmitted. Examples of such information include sound (an audio signal), images (a video signal) or data (a digital signal). Devices that contain radio transmitters include radar equipment, two-way radios, cell phones and other cellular devices, wireless computer networks and network devices, GPS navigation devices, radio telescopes, Radio Frequency Identification (RFID) chips, Bluetooth enabled devices, and garage door openers.

“Transmitter” generally refers to a device configured to transmit, for example, digital or analog signals carrying information via electromagnetic energy. A transmitter using electromagnetic energy may operate with an antenna or antenna system to produce electromagnetic waves passing through a medium such as air, a conductor such as a metallic cable, or through glass fibers. A transmitter can be a separate piece of electronic equipment, or an electrical circuit within another electronic device. A transmitter and a receiver combined in one unit are called a “transceiver”.

“Triggering a Rule” generally refers to an outcome that follows when all elements of a conditional statement expressed in a rule are satisfied. In this context, a conditional statement may result in either a positive result (all conditions of the rule are satisfied by the data), or a negative result (at least one of the conditions of the rule is not satisfied by the data) when compared to available data. The conditions expressed in the rule are triggered if all conditions are met causing program execution to proceed along a different path than if the rule is not triggered.

“Wi-Fi” generally refers to a family of wireless network protocols that are based on the IEEE 802.11 family of standards. Wi-Fi networks are commonly used for local area networking of devices so that these devices may communicate with each other and with a broader computer network such as the Internet. Wi-Fi protocols define how enabled devices may exchange data wirelessly via radio waves. Wi-Fi wireless connections may be useful for providing wireless communications links between desktop and laptop computers, cameras, tablet computers, smartphones, smart TVs, printers, smart speakers, and the like with wireless network access devices to connect them to the Internet.

Wi-Fi uses multiple parts of the IEEE 802 protocol family and is designed to be operable seamlessly with wired communication protocols, such as Ethernet. Compatible devices can network through wireless access points to each other as well as to wired devices and the Internet. The different versions of Wi-Fi are specified by various IEEE 802.11 protocol standards, with different radio technologies determining radio bands, and the maximum ranges, and data rates that may be achieved. For example, Wi-Fi uses the 2.4 gigahertz (120 mm wavelength) UHF and 5 gigahertz (60 mm wavelength) SHF radio bands, which may be subdivided into multiple channels.

The radio frequencies typically used by Wi-Fi transmitters and receivers have relatively high absorption rates and work best for line-of-sight communication links. Many common obstructions such as walls, pillars, home appliances, etc. may greatly reduce range, but interference between different networks in crowded environments is usually minimal. In one example, a Wi-Fi network access point may have a range of about 65 feet indoors, or as much as 500 feet outdoors. Wireless network access points may include a single transmitter/receiver to cover a single room to a multiple transmitters/receivers spread over square miles of area to provide overlapping access to client devices.

What is claimed is:

1. A method, comprising:
receiving device information from a new network access device using one or more existing network access devices, wherein the one or more existing network access devices are arranged and configured to operate as a single logical network segment;
determining that the device information is valid;
sending access parameters from the existing network access device to the new network access device; and
configuring the new network access device to operate together with the existing network devices.

2. The method of claim 1, wherein determining that the device information is valid includes using a validation service accessible by the one or more existing network access devices via a communication link.

3. The method of claim 1, wherein the device information is encrypted.

4. The method of claim 1, wherein the device information includes a firmware version, model name and/or number, and a MAC address, or any combination thereof.

5. The method of claim 1, comprising:
broadcasting a vendor specific information element from the existing network access devices.

6. The method of claim 1, wherein an information element broadcast by the existing network access devices includes a serial number, model name and/or number, MAC address, or any combination thereof.

7. The method of claim 1, wherein an information element broadcast by the existing network access devices is encrypted.

8. The method of claim 1, wherein determining that the device information is valid includes sending vendor specific information about the new or existing network access devices to a validation service accessible by the one or more existing network access devices via a communication link.

9. The method of claim 1, comprising:
receiving user input from a remote computing device confirming that the new device should be configured to operate with the existing devices.

10. The method of claim 1, comprising:
generating a binding key specific to the new access device and the existing access devices.

11. The method of claim 1, comprising:
activating a temporary SSID provided by the existing network access devices.

12. The method of claim 1, comprising:
activating a WPS communication link between the new and existing access devices.

13. The method of claim 1, comprising:
sending a primary SSID from the existing access devices to the new access device.

14. The method of claim 1, comprising:
connecting the new access device to the existing access devices using a primary SSID that is different from a temporary SSID.

15. The method of claim 1, comprising:
encrypting a primary SSID and password before sending the primary SSID from the existing network access devices to the new network access device.

16. The method of claim 1, comprising:
deactivating a temporary SSID.

17. The method of claim 1, wherein determining that the device information is valid includes using a public key to validate that the new access device is operable to operate in conjunction with the existing network access devices.

18. The method of claim 1, wherein the existing network access devices are arranged and configured to operate as a mesh network.

19. The method of claim 1, comprising:
associating the new network access device with a user account maintained by an account service.

20. The method of claim 1, wherein a temporary SSID is generated by the existing network access devices, and wherein the temporary SSID is generated randomly.

21. The method of claim 1, wherein configuring the new network access device includes integrating the new network access devices to operate along with the existing access devices as part of a single logical network segment.
